(19) United States
(12) Patent Application Publication
(10) Pub. No.: US 2019/0105963 A1
(43) Pub. Date: Apr. 11, 2019

(54) INTEGRATED COOLING, HEATING, AND DEHUMIDIZING AIR-CONDITIONING SYSTEM FOR ELECTRIC VEHICLE

(71) Applicant: TONG BOU CHANG, TAINAN CITY (TW)

(72) Inventor: TONG BOU CHANG, TAINAN CITY (TW)

(21) Appl. No.: 15/728,620

(22) Filed: Oct. 10, 2017

(51) Int. Cl. B60H 1/00; B60H 1/32; B60H 1/22; B60H 3/02

(52) U.S. Cl. CPC B60H 1/00392; B60H 1/00321; B60H 1/00485; B60H 3/024; B60H 1/3227; B60H 1/22; B60H 1/00885

(57) ABSTRACT

An integrated cooling, heating, and dehumidizing air-conditioning system for an electric vehicle includes an inverter compressor, a four-way valve connected to the inverter compressor, first, second, and third heat exchangers connected to the four-way valve, a three-way valve connected to the heat exchanger, a ring-shaped thermoelectric heater connected to the inverter compressor and the second heat exchanger, an expansion valve connected to the second and third heat exchangers, and a check value connected to the first, second, and third heat exchangers, so that the air-conditioning system provides different refrigeration and heating methods operated according to the requirements of a driver and passengers and switched according to different climates.

### FIELD OF INVENTION

The present invention relates to an integrated cooling, heating, and dehumidizing air-conditioning system for an electric vehicles, more particularly to the air-conditioning system using first, second, and third heat exchangers and different refrigeration and heating methods to providing different functions of supplying cold air, heating up the air to a slightly warm, mid warm, very warm and super warm level while performing dehumidization, and heating up the air without performing dehumidization for the electric vehicle, and these functions may be switched according to different climates.

### BACKGROUND OF INVENTION

### 1. Description of the Related Art

The use of electric motor as the power of a motor vehicle is a future trend, and its advantage resides on that the electric motor can improve the air pollution issue of the traditional fuel vehicle which discharges a large quantity of exhaust gas. In present existing fuel vehicles, the power of an air-conditioning system compressor comes from a fuel engine, but the electric vehicle has no fuel engine, and the compressor of its air-conditioning system cannot be driven by the engine. Therefore, the electric vehicle needs a set of air-conditioning system with the cooling, heating and dehumidizing functions to meet the application requirements.

At this stage, the warm air of the heating and cooling air-conditioning system of a domestic or foreign electric vehicle is supplied by a heat pump. With reference to FIG. 1 for a conventional heating and cooling air-conditioning system, the conventional heating and cooling air-conditioning system comprises a four-way valve Z1, an expansion valve Z2 and a plurality of check valves Z3, and produced refrigeration and heat by changing the refrigerant flow, but the conventional heating and cooling air-conditioning system does not have the functions of dehumidizing the air in the car and defogging and defrosting a windshield of the car. If the water vapor discharged by the driver or passengers in the car cannot be dehumidized, the water vapor will be condensed to form a white fog on the inner side of the windshield or windows, and such fog may affect the driver's vision and the driving safety.

To overcome the aforementioned problems including the fog or frost formed on the windshield of the electric vehicle due to temperature or humidity difference, the present invention improve the traditional compressor based on the present existing air-conditioning system and adopts an inverter compressor capable of adjusting the output according to load, and appropriately adjusts the area of the heat exchangers, and further adds a four-way valve, a heat exchanger, a ring-shaped thermoelectric heater, an expansion valve and a check valve, so that the cooling and heating functions of the air-conditioning system can be switched according to the requirements of the driver and passengers, and the heat exchanger of the air-conditioning system has the functions of an evaporator and a condenser, and different refrigeration and heating methods of the heat exchangers can be used to provide the functions of supplying cold air or heating up the air to different levels to cope with its use in different climates.

### 2. Summary of the Invention

Therefore, it is a primary objective of the present invention to overcome the drawbacks of the prior art by providing an integrated cooling, heating, and dehumidizing air-conditioning system for an electric vehicle, and the air-conditioning system comprises: an inverter compressor, for pressuring and delivering a refrigerant to circulate the refrigerant in the system, and having an acting end A and an acting end B; a four-way valve, coupled to the acting end B of the inverter compressor, for adjusting the flow of the refrigerant; first, second, and third heat exchangers, coupled to the four-way valve, for absorbing and eliminating external heat in the electric vehicle; two three-way valves (B), coupled to the acting ends A of the first, second, and third heat exchangers, for adjusting the flow of the refrigerant; first and second ring-shaped thermoelectric heaters, coupled to the inverter compressor and the second heat exchanger respectively, for vaporizing the refrigerant by heating; first and second expansion valves, coupled to the second and third heat exchangers respectively, for adjusting the flow of the refrigerant; and first, second, third and fourth check valves, coupled to the first, second, and third heat exchangers, for delivering the refrigerant, and preventing a backflow of the refrigerant.

The first heat exchanger has an acting end C and an acting end D, and the acting end C is provided for coupling the first heat exchanger and the four-way valve, and the second heat exchanger has an acting end E and acting end F, and the acting end F is provided for coupling the second heat exchanger and the four-way valve, and the third heat exchanger has an acting end G and an acting end H.

The three-way valve (A) is coupled to the three-way valve (B) and the acting end G and acting end H of the third heat exchanger, and the three-way valve (B) is coupled to the three-way valve (A) and the acting end C and acting end D of the first heat exchanger.

The first expansion valve is installed between the three-way valve (A) and the acting end E of the second heat exchanger, and the second expansion valve is installed between the acting end D of the first heat exchanger and the acting end E of the second heat exchanger.

The first ring-shaped thermoelectric heater is installed between the acting end A of the inverter compressor and the four-way valve, and the second ring-shaped thermoelectric heater is installed next to the second heat exchanger.

The first check valve is installed between the acting end D of the first heat exchanger and the second expansion valve, and the second check valve is installed between the acting end E of the second heat exchanger and the first and second expansion valves, and the third check valve is installed between the three-way valve (B), the acting end C of the first heat exchanger, and the four-way valve, and the fourth check valve is installed between the three-way valve (B) and the acting end D of the first heat exchanger.

The first heat exchanger is disposed outside the electric vehicle, and the second and third heat exchanger id disposed inside the electric vehicle.

The present invention discloses an integrated cooling, heating, and dehumidizing air-conditioning system for an electric vehicle, wherein the cooling, heating, and dehumidizing functions of the air-conditioning system can be switched according to the requirements of the driver and passengers, and the first, second, and third heat exchangers have the evaporator and condenser, and the first, second, and third heat exchangers provides different refrigeration and heating methods, so that the air-conditioning system of the electric vehicle has the functions of supplying cold air, and heating up the air to various different levels while performing or not performing the dehumidization, and these functions can be switched to cope with its use in different climates.

### BRIEF DESCRIPTION OF THE DRAWINGS

FIG. 1 is a circuit diagram of a conventional heating and cooling air-conditioning system;

FIG. 2 is a circuit diagram of a heating and cooling air-conditioning system of the present invention;

FIG. 3 is a flow chart of supplying cold air by a heating and cooling air-conditioning system of the present invention;

FIG. 3 is a flow chart of supplying cold air by a heating and cooling air-conditioning system of the present invention;

FIG. 4 is a flow chart of heating up the air to a slightly warm level while performing dehumidization by a heating and cooling air-conditioning system of the present invention;

FIG. 5 is a flow chart of heating up the air to a warm level while performing dehumidization by a heating and cooling air-conditioning system of the present invention;

FIG. 6 is a flow chart of heating up the air to a very warm level while performing dehumidization by a heating and cooling air-conditioning system of the present invention;

FIG. 7 is a flow chart of heating up the air to a super warm level while performing dehumidization by a heating and cooling air-conditioning system of the present invention; and

FIG. 8 is a flow chart of heating up the air without performing dehumidization by heating and cooling air-conditioning system of the present invention.

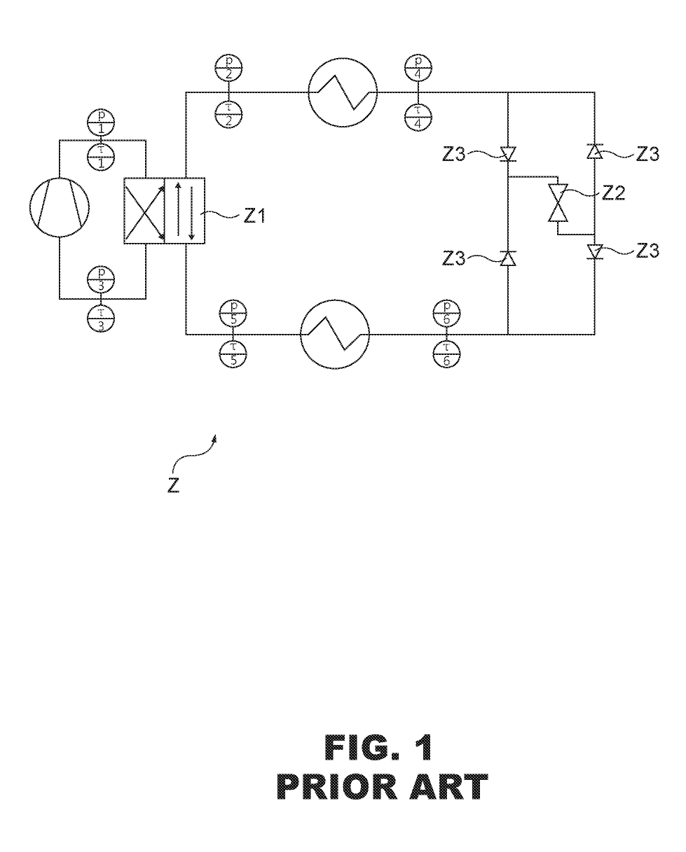

### DESCRIPTION OF THE PREFERRED EMBODIMENTS

The above and other objects, features and advantages of this disclosure will become apparent from the following detailed description taken with the accompanying drawings.

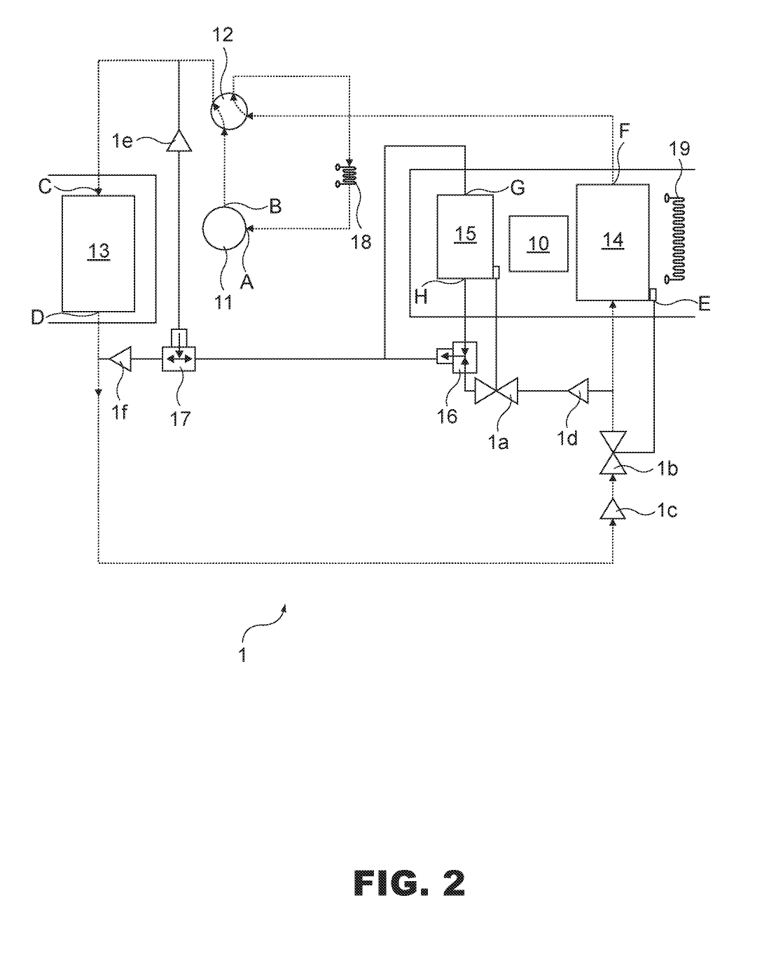

With reference to FIG. 2 for an integrated cooling, heating, and dehumidizing air-conditioning system 1 for an electric vehicle in accordance with the present invention, the air-conditioning system 1 comprises:

an inverter compressor 11, having an acting end A and an acting end B;

a four-way valve 12, coupled to the acting end B of the inverter compressor 11;

at least three (including the first, second, and third) heat exchangers 13, 14, 15, and the first heat exchanger 13 having an acting end C and an acting end D, and the acting end C of the first heat exchanger 13 being coupled to the four-way valve 12, and the second heat exchanger 14 having an acting end E and an acting end F, and the acting end F of the second heat exchanger 14 being coupled to the four-way valve 12, and the third heat exchanger 15 having an acting end G and an acting end H, and the first heat exchanger 13 being disposed outside the electric vehicle, and the second and third heat exchanger 14, 15 inside the electric vehicle;

at least two three-way valves (including the three-way valve (A) and three-way valve (B) 16, 17), and the three-way valve (A) 16 being coupled to the three-way valve (B) 17, and the acting end G and acting end H of the third heat exchanger 15, and the three-way valve (B) 17 being coupled to the three-way valve (A) 16, and the acting end C and acting end D of the first heat exchanger 13;

at least two (including the first and second) ring-shaped thermoelectric heaters 18, 19, and the first ring-shaped thermoelectric heater 18 being installed between the acting end A of the inverter compressor 11 and the four-way valve 12, and the second ring-shaped thermoelectric heater 19 being installed next to the second heat exchanger 14;

at least two (including the first and second) expansion valves 1a, 1b, and the first expansion valve 1a being installed between the three-way valve (A) 16 and the acting end E of the second heat exchanger 14, and the second expansion valve 1b being installed between the acting end D of the first heat exchanger 13 and the acting end E of the second heat exchanger 14;

at least four (including the first, second, third and fourth) check valves 1c, 1d, 1e, 1f, and the first check valve 1c being installed between the acting end D of first heat exchanger 13 and the second expansion valve 1b, and the second check valve 1d being installed between the acting end E of the second heat exchanger 14 and the first and second expansion valves 1a, 1b, and the third check valve 1e being installed between the three-way valve (B) 17, the acting end C of the first heat exchanger 13, and the four-way valve 12, and the fourth check valve 1f being installed between the three-way valve (B) 17 and the acting end D of the first heat exchanger 13.

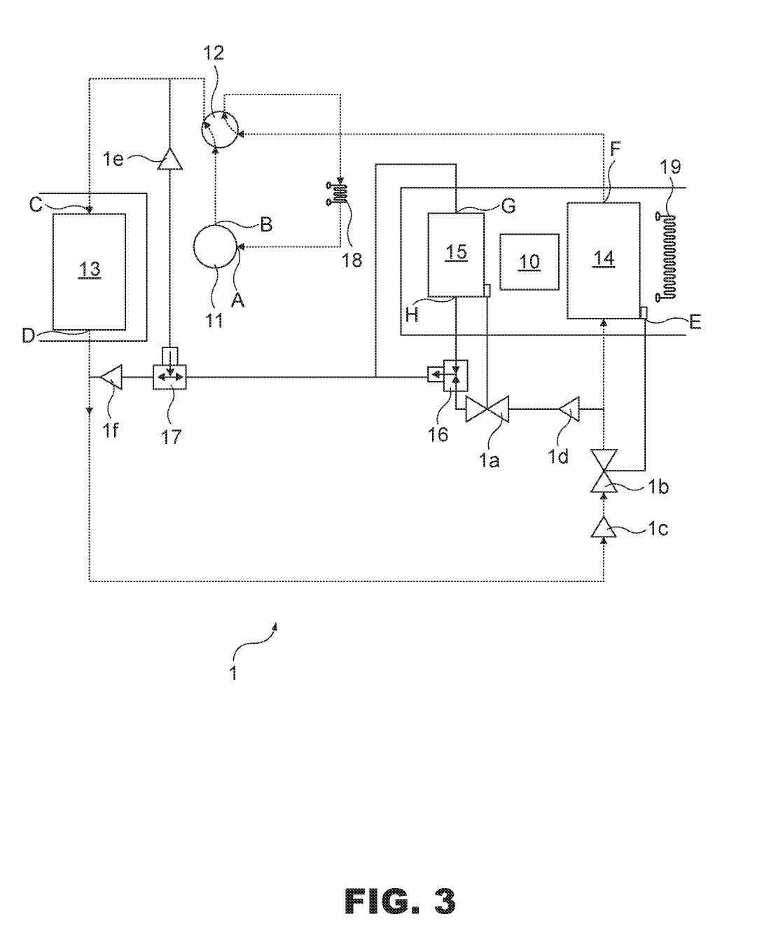

With reference to FIG. 3 for a cooling, heating, and dehumidizing air-conditioning system that supplies cold air in accordance with a preferred embodiment of the present invention, when the inverter compressor 11 of the invention is used for supplying cold air, and the temperature inside/outside the electric vehicle, the load, and the speed are used as reference and the output of the inverter compressor 11 can be controlled accurately to achieve different level of coldness, and an inverter fan or blower 10 inside/outside the electric vehicle may change its wind from the maximum to a small wind, and the system operates its refrigeration process as described below. The four-way valve 12 is switched to a cold air mode, and the inverter compressor 11 starts operating and pressurizing and delivering the refrigerant to the first heat exchanger 13. After the heat dissipation, the refrigerant is passed through the first check valve 1c and second expansion valve 1b to adjust its flow, and then the refrigerant is entered into the second heat exchanger 14 to absorb the heat inside the electric vehicle, and finally returned to the inverter compressor 11 through the four-way valve 12, so as to complete a cycle.

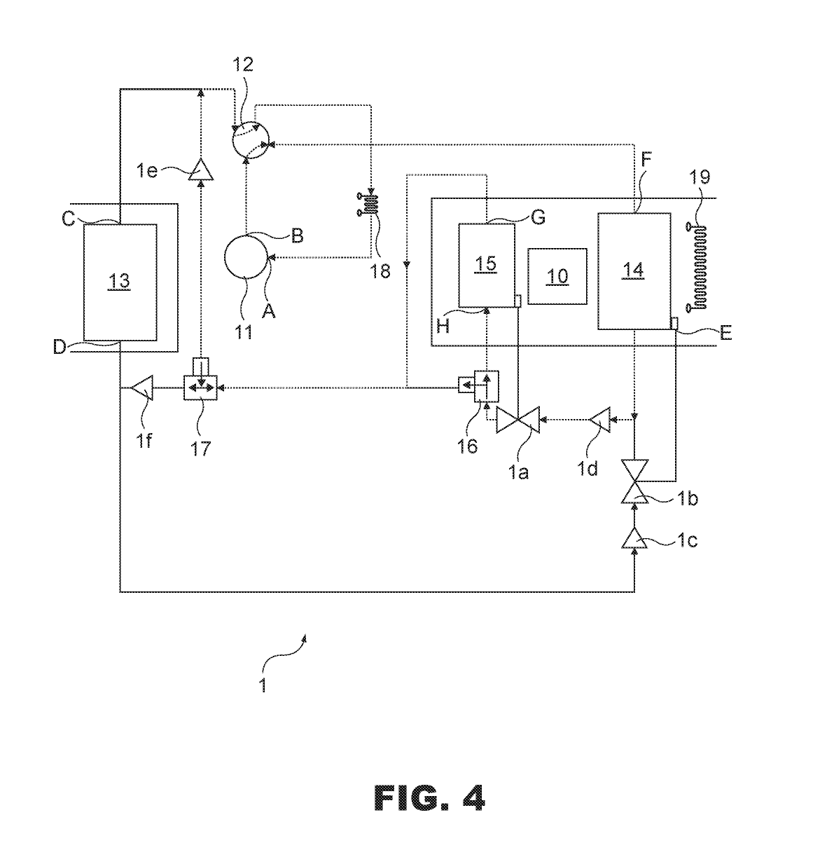

With reference to FIG. 4 for a cooling, heating, and dehumidizing air-conditioning system that heats up the air to a slightly warm level while performing dehumidization in accordance with a preferred embodiment of the present invention, the four-way valve 12 is switched to a warm air mode, and the inverter compressor 11 starts operating to pressurize and deliver the refrigerant to the second heat exchanger 14 through the four-way valve 12 to exchange the heat and air in the electric vehicle, so as to achieve the effect of heating up the air in the electric vehicle to a slightly warm level. The refrigerant is changed from a gas state to a liquid state. After the refrigerant flows through the first expansion valve 1a, and enters into the third heat exchanger 15 through the three-way valve (A) 16, the refrigerant with an adjusted refrigeration level is vaporized due to the pressure difference and provided for absorbing the heat of the third heat exchanger 15 and then the refrigerant flows back to the inverter compressor 11, and the blower 10 blowing at some portions inside the vehicle sucks the moisture and the low-temperature air in the electric vehicle to the third heat exchanger 15 to perform the dehumidization, and condense and discharge the extra water vapor to the outside, and the dehumidized air entering into the second heat exchanger 14 is heated and delivered into the electric vehicle, so as to easy the driver and passengers' discomfort caused by the low temperature and high humidity, and overcome the problems of having water vapor condensed at the windshield caused by excessive moisture in the electric vehicle or fog formed on the windows of the electric vehicle by the water vapor exhaled from the driver or passengers.

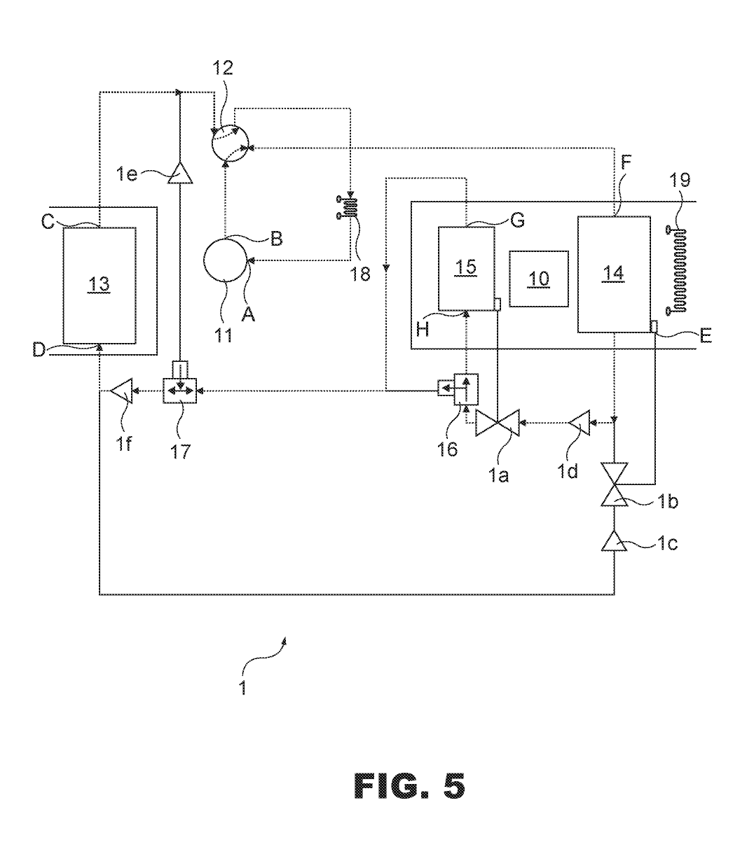

With reference to FIG. 5 for a cooling, heating, and dehumidizing air-conditioning system that heats up the air to a warm level while performing dehumidization in accordance with a preferred embodiment the present invention, the four-way valve 12 is still set to the warm air mode, and the inverter compressor 11 starts operating to pressurize and deliver the refrigerant to the second heat exchanger 14 through the four-way valve 12 to exchange the heat and air in the electric vehicle, so as to achieve the effect of heating the air in the vehicle. The refrigerant is changed from a gas state to a liquid state. After the refrigerant flows through the first expansion valve 1a, the refrigerant enters into the third heat exchanger 15 through the three-way valve (A) 16, and the refrigerant with an adjusted refrigeration level is vaporized by the pressure different to absorb the heat of the third heat exchanger 15, the refrigerant flows to the first heat exchanger 13 outside the vehicle to further absorb the heat outside the vehicle before returning to the inverter compressor 11, and the blower 10 blowing air to some portions inside the vehicle sucks the moisture and the low-temperature air in the electric vehicle to the third heat exchanger 15 to perform the dehumidization, and condense and discharge the extra water vapor to the outside, and the dehumidized air entering into the second heat exchanger 14 is heated and delivered into the electric vehicle, so as to easy the driver and passengers' discomfort caused by the low temperature and high humidity, and overcome the problems of having water vapor condensed at the windshield caused by excessive moisture in the electric vehicle or fog formed on the windows of the electric vehicle by the water vapor exhaled from the driver or passengers. In addition, the dehumidization can be performed with high efficiency and different stages according to the number of people inside the vehicle.

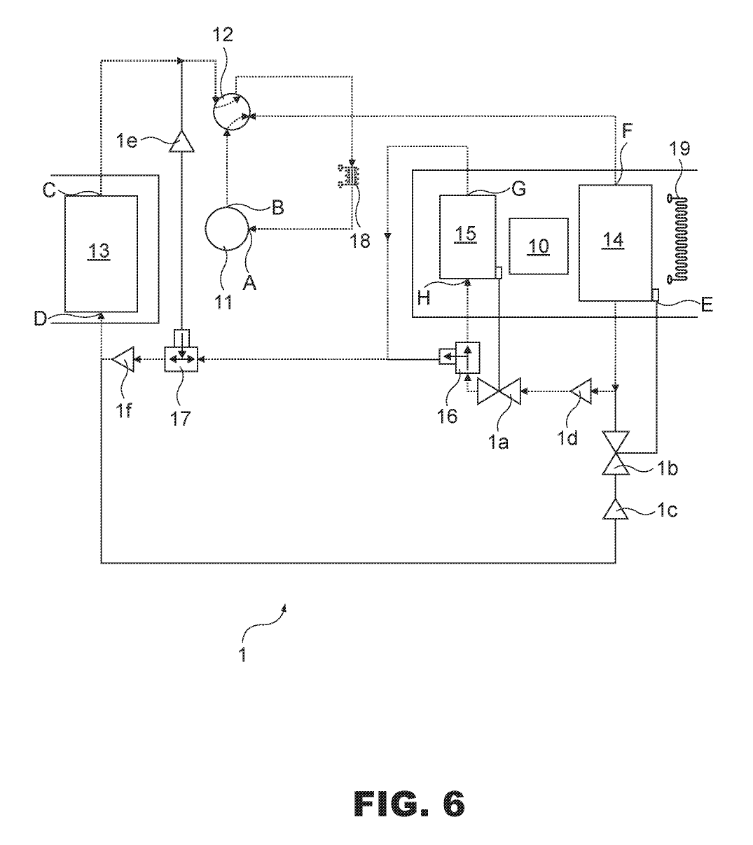

With reference to FIG. 6 for a cooling, heating, and dehumidizing air-conditioning system that heats up the air to a very warm level while performing dehumidization in accordance with a preferred embodiment the present invention, the four-way valve 12 is still set to the warm air mode, and the inverter compressor 11 of the cooling, heating, and dehumidizing air-conditioning system outputs the refrigerant to the second heat exchanger 14 through a pipeline to release heat, and then the refrigerant flows through the first expansion valve 1a and enters into the third heat exchanger 15 through the three-way valve (A) 16 to absorb the heat of the air in the vehicle and dehumidize, and the refrigerant with the absorbed heat flows to the first heat exchanger 13 outside the vehicle to further absorb the heat outside the vehicle, and finally the refrigerant returns to the inverter compressor 11, and some of the interior space of the vehicle is blown by the blower 10 to extract the air in the vehicle, and the third heat exchanger 15 dehumidizes the air and adjusts the humidity of the air, and then the adjusted air is guided into the second heat exchanger 14 for a heat exchange, and the warm air with the absorbed heat is delivered into the vehicle by the fan to increase the temperature inside the vehicle. At this stage, the difference between this embodiment and the previous embodiment resides on that the acting end A of the inverter compressor 11 has a first ring-shaped thermoelectric heater 18 capable of driving the refrigerant to absorb heat and be vaporized, so as to achieve the heating effect.

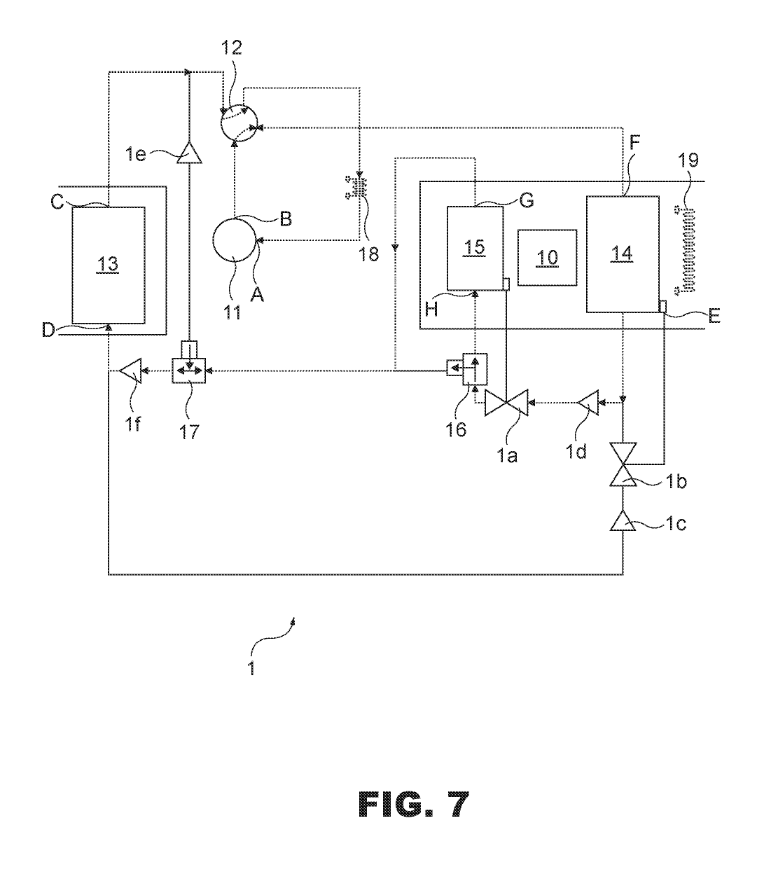

With reference to FIG. 7 for a cooling, heating, and dehumidizing air-conditioning system that heats up the air to a super warm level while performing dehumidization in accordance with a preferred embodiment the present invention, the first, second and third heat exchangers 13, 14, 15 capture and discharge the heat from the interior and exterior of the vehicle by different heating methods, and the air entering into the vehicle is dehumidized by the third heat exchanger 15 and then heated by the second heat exchanger 14. If the system provides insufficient heat source at this moment, the second ring-shaped thermoelectric heater 19 will increase the temperature in the vehicle according to the heat generated by the second heat exchanger 14.

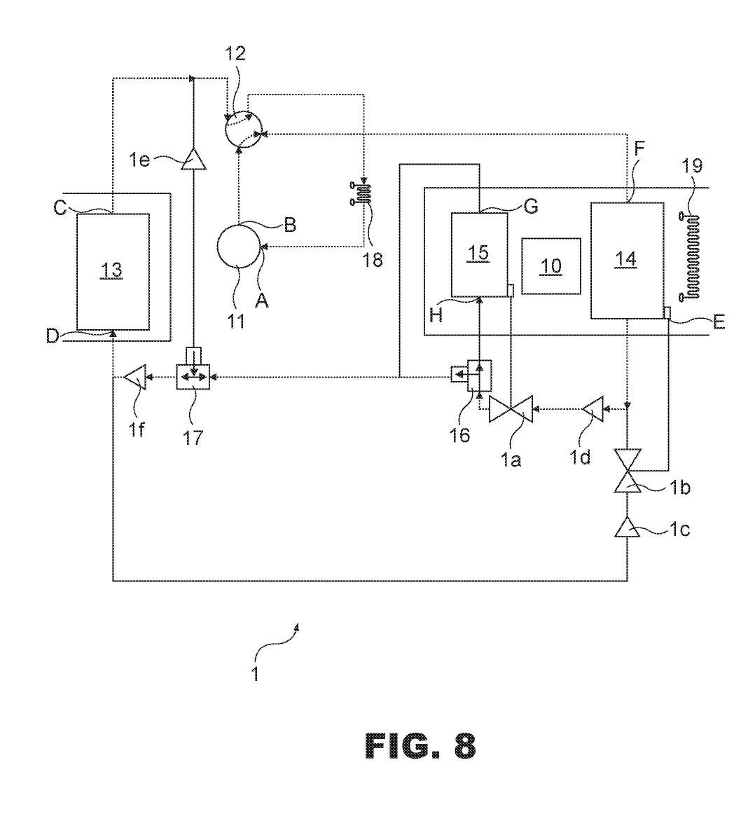

With reference to FIG. 8 for a cooling, heating, and dehumidizing air-conditioning system that heats up the air to a warm level without performing dehumidization in accordance with a preferred embodiment the present invention, the dehumidization is not needed when the humidity is not high, so that it can save power by just heating the air, or the driver just needs the warm air, so that the dehumidization function may not be enabled. Now, the four-way valve 12 is switched to the warm air mode, and the inverter compressor 11 starts operating to pressurize and deliver the refrigerant to the second heat exchanger 14 through the four-way valve 12 to exchange the heat and air in the vehicle and achieve the effect of heating up the air. The refrigerant is changed from the gas state to the liquid state. After the refrigerant flows through the first expansion valve 1a, the refrigerant enters from the three-way valve (A) 16 into the three-way valve (B) 17 directly and then enters into the first heat exchanger 13 to absorb heat before returning to the inverter compressor 11. If the refrigerant cannot be vaporized completely before the refrigerant enters into the inverter compressor 11, the first ring-shaped thermoelectric heater 18 will be turned on to heat up the refrigerant in the pipeline, so that the refrigerant can absorb heat to become a complete gaseous refrigerant, and then the refrigerant enters into the inverter compressor 11 for compression, and the compressed refrigerant enters into the condenser, and the blower 10 extracts the air in the vehicle to increase the temperature in the vehicle. If the electric vehicle is situated at a very cold area, then the second ring-shaped thermoelectric heater 19 may be turned on, and the heat produced by the second ring-shaped thermoelectric heater 19 can increase the temperature inside the vehicle.

In summation of the description above, the integrated cooling, heating, and dehumidizing air-conditioning system for electric vehicles in accordance with the present invention has the following effects and advantages:

1. The integrated cooling, heating, and dehumidizing air-conditioning system for electric vehicles in accordance with the present invention may switch to cooling, heating, and dehumidizing functions to cope with the driver and passengers' requirements, and the first, second, and third heat exchangers have the functions of the evaporator and condenser, and different refrigeration and heating methods of the first, second, and third heat exchangers can be used to cope with the use of the air-conditioning system in different climates.

2. The integrated cooling, heating, and dehumidizing air-conditioning system for electric vehicles in accordance with the present invention can overcome the problems of the conventional heating and cooling air-conditioning system for electric vehicles that fails to dehumidize the air in the vehicle or defog and defrost the windshield.

3. The integrated cooling, heating, and dehumidizing air-conditioning system for electric vehicles in accordance with the present invention provides the functions of supplying cold air, heating up the air to a slightly warm level while performing dehumidization, heating up the air to a mid warm level while performing dehumidization, heating up the air to a very warm level while performing dehumidization, heating up the air to a super warm level while performing dehumidization, and heating up warm air without performing dehumidization. In view of the future development trend of the electric vehicles, the air-conditioning system will be different from the present existing engine motor vehicles, so that the present invention integrates the cooling, heating, and dehumidizing functions into the air-conditioning system to meet the industrial requirements.

Therefore, the integrated cooling, heating, and dehumidizing air-conditioning system for electric vehicles in accordance with the present invention effectively overcomes the aforementioned drawbacks of the prior art, and complies with the patent application requirements, and thus is duly filed for patent application.

While the invention has been described by means of specific embodiments, numerous modifications and variations could be made thereto by those skilled in the art without departing from the scope and spirit of the invention set forth in the claims.

What is claimed is:

1. An integrated cooling, heating, and dehumidizing air-conditioning system for an electric vehicle, comprising:
an inverter compressor, for pressuring and delivering a refrigerant to circulate the refrigerant in the system, and having an acting end A and an acting end B;
a four-way valve, coupled to the acting end B of the inverter compressor, for adjusting the flow of the refrigerant;
first, second, and third heat exchangers, coupled to the four-way valve, for absorbing and eliminating external heat in the electric vehicle;
two three-way valves (B), coupled to the acting ends A of the first, second, and third heat exchangers, for adjusting the flow of the refrigerant;
first and second ring-shaped thermoelectric heaters, coupled to the inverter compressor and the second heat exchanger respectively, for vaporizing the refrigerant by heating;
first and second expansion valves, coupled to the second and third heat exchangers respectively, for adjusting the flow of the refrigerant; and
first, second, third and fourth check valves, coupled to the first, second, and third heat exchangers, for delivering the refrigerant, and preventing a backflow of the refrigerant.

2. The integrated cooling, heating, and dehumidizing air-conditioning system for an electric vehicle according to claim 1, wherein the first heat exchanger has an acting end C and an acting end D, and the acting end C is provided for coupling the first heat exchanger and the four-way valve, and the second heat exchanger has an acting end E and acting end F, and the acting end F is provided for coupling the second heat exchanger and the four-way valve, and the third heat exchanger has an acting end G and an acting end H.

3. The integrated cooling, heating, and dehumidizing air-conditioning system for an electric vehicle according to claim 1, wherein the three-way valve (A) is coupled to the three-way valve (B) and the acting end G and acting end H of the third heat exchanger, and the three-way valve (B) is coupled to the three-way valve (A) and the acting end C and acting end D of the first heat exchanger.

4. The integrated cooling, heating, and dehumidizing air-conditioning system for an electric vehicle according to claim 1, wherein the first expansion valve is installed between the three-way valve (A) and the acting end E of the second heat exchanger, and the second expansion valve is installed between the acting end D of the first heat exchanger and the acting end E of the second heat exchanger.

5. The integrated cooling, heating, and dehumidizing air-conditioning system for an electric vehicle according to claim 1, wherein the first ring-shaped thermoelectric heater is installed between the acting end A of the inverter compressor and the four-way valve, and the second ring-shaped thermoelectric heater is installed next to the second heat exchanger.

6. The integrated cooling, heating, and dehumidizing air-conditioning system for an electric vehicle according to claim 1, wherein the first check valve is installed between the acting end D of the first heat exchanger and the second expansion valve, and the second check valve is installed between the acting end E of the second heat exchanger and the first and second expansion valves, and the third check valve is installed between the three-way valve (B), the acting end C of the first heat exchanger, and the four-way valve, and the fourth check valve is installed between the three-way valve (B) and the acting end D of the first heat exchanger.

7. The integrated cooling, heating, and dehumidizing air-conditioning system for an electric vehicle according to claim 1, wherein the first heat exchanger is disposed outside the electric vehicle, and the second and third heat exchanger id disposed inside the electric vehicle.
